(19) United States
(12) Patent Application Publication
(10) Pub. No.: US 2015/0272711 A1
(43) Pub. Date: Oct. 1, 2015

(54) DENTAL FLOSS APPARATUS, SYSTEM AND METHOD FOR CLEANING TEETH

(71) Applicant: Nasreen Gagan, Skokie, IL (US)

(72) Inventor: Nasreen Gagan, Skokie, IL (US)

(21) Appl. No.: 14/669,338

(22) Filed: Mar. 26, 2015

Related U.S. Application Data
(60) Provisional application No. 61/971,178, filed on Mar. 27, 2014.

(51) Int. Cl. A61C 15/04

(52) U.S. Cl. CPC A61C 15/042

(57) ABSTRACT

A dental floss apparatus, a system and a method for cleaning teeth removes plaque and/or food and/or debris between the teeth and the gums. Elements may be attached to the dental floss that may have various sizes, configurations, structures, shapes, textures and the like to provide cleaning solutions. The user selects elements corresponding to and/or appropriate for the spaces between the teeth and/or the gums to be cleaned.

### CROSS REFERENCE TO RELATED APPLICATION

This application claims the benefit of U.S. Provisional Application No. 61/971,178, filed Mar. 27, 2014 (Mar. 27, 2014), which is hereby incorporated in its entirety.

### BACKGROUND OF THE INVENTION

The present invention relates to dental floss. More specifically, the present invention relates to a dental floss apparatus, a system and a method for cleaning teeth. Further, the present invention relates to a dental floss apparatus having various elements to form a system for cleaning spaces between the teeth and the gums.

It is generally known to provide dental care to a patient. Typically, the patient may visit a dentist and/or a dental hygienist. The dentist may examine the patient using various techniques and/or take x-ray images of the mouth. After reviewing the x-rays and/or after conducting the examination, the dentist and/or the dental hygienist may clean the teeth of the patient using dental instruments and/or dental floss. The dentist and/or the dental hygienist may then provide the patient with dental floss for cleaning the teeth at home.

Typically, the dental floss (hereinafter, referred to as floss) is a length of flexible, string-like material. The floss is generally either waxed or unwaxed. Some floss is available in different flavors. Different types of floss have certain benefits and/or limitations. For example, the texture of the floss may be suited for certain types of flossing. Some floss is designed to be relatively thin and smooth which allows easier passage through the space between adjacent teeth. Other floss is designed to be relatively thick, textured and/or coarse to remove plaque and other debris more effectively from larger spaces between adjacent teeth.

Typically, users often prefer the ease of use associated with relatively thin and smooth floss. However, dentists often recommend the thick and/or coarse floss for more effective cleaning.

Typically, floss is used to remove dental plaque and/or food particles between teeth. Dental plaque is a bacterial biofilm that may build up on the teeth and may cause damage to the teeth, such as cavities and/or dental diseases, such as periodontal disease, for example. To prevent such problems, practicing regular dental hygiene, such as tooth brushing and/or flossing, may be required. However, brushing the teeth with toothpaste may fail to reach dental plaque and/or food particles in the spaces between teeth which may contribute to the formation of dental plaque. Therefore, flossing the spaces between teeth is an important part of dental hygiene.

In addition to the dental floss, the dentist and/or the dental hygienist may provide the patient with instructions for cleaning teeth with the dental floss. Of course, flossing may produce better results when performed properly. However, the flossing may be tedious and/or time-consuming for the patient. In some cases, the flossing may cause pain to the patient. Accordingly, the patient may not be motivated to perform the flossing and may abandon the flossing or otherwise not regularly perform the flossing to assist with and/or to clean the teeth. As a result, the teeth may not be fully cleaned. In other cases, the patient may not have time to perform the flossing. Failure to perform the flossing may prevent or otherwise hinder complete cleaning of the teeth. Attempts have been made to make flossing easier and/or more effective.

In common flossing technique, the user draws the floss around each side of a tooth through spaces between the teeth. The floss passes beneath the gum line. The moving floss adheres to dental plaque and/or particles by the friction of the floss on the teeth and/or the gums. The floss may remove plaque and/or particles as the floss contacts the side of each tooth. However, for a variety of reasons, flossing between the spaces may fail to draw out particles and/or the dental plaque between wide spaces. Typical floss may also be ineffective and/or time consuming in wider spaces. For example, the floss may be worked around each tooth surface separately and may be imprecisely dragged over the gum surface of a wider space which may limit the utility of floss for removing particles. Further, the planar element of certain floss may merely glide over plaque deposits and/or lodged particles failing to remove them.

Moreover, as people age, the gums naturally recede which causes larger spaces and/or gaps between the teeth and the gums. Also, current disease and/or past periodontal disease may create larger openings between the teeth previously occupied by where gum tissue used to be. The larger spaces allow food to collect and cause decay around the gum line areas between the teeth. The larger spaces accumulate more than the normal amount of food. As a result, the difficulty in removing the food with regular floss is increased.

A need, therefore, exists for a dental floss apparatus for cleaning teeth in a patient. A need also exists for a dental floss apparatus and a method for reducing an amount of patient cooperation and/or flossing required for cleaning the teeth.

### SUMMARY OF THE INVENTION

The present invention relates to dental floss. More specifically, the present invention relates to a dental floss apparatus, a system and a method for cleaning teeth. Further, the present invention relates to a dental floss apparatus having various elements to form a system for cleaning spaces between the teeth and the gums.

To this end, in an embodiment of the present invention, a dental floss system for cleaning between adjacent teeth in a mouth of an individual wherein a space is defined between the adjacent teeth is provided. The dental floss system has a flexible material that extends through the space wherein the flexible material has a first length and a first cross section and further wherein the flexible material has a surface to provide abrasion against the adjacent teeth wherein the surface has a first texture. Further, the dental floss system has a plurality of projections to contact the adjacent teeth wherein the projections are spaced at intervals along the first length of the flexible material wherein each projection has a second length and a second cross section that is greater than the first cross section of the flexible material and further wherein each projection has a second texture that is different than the first texture of the flexible material.

In an embodiment, the dental floss system has a plurality of bristles extending from the projections wherein the bristles extend radially from the projections and longitudinally along the second lengths of the projections.

In an embodiment, the dental floss system has ridges extending from the projections.

In an embodiment, the dental floss system has a coating on the surface of the flexible material.

In an embodiment, the dental floss system has a plurality of fibers extending outwardly from the projections wherein the fibers are made from plastic.

In an embodiment, the dental floss system has a first loop and a second loop extending from the projections.

In an embodiment, the dental floss system has strings extending from the projections wherein the strings and the projections are made from the same material.

In another embodiment, a dental floss apparatus for cleaning between adjacent teeth in a mouth of an individual wherein a space is defined between the adjacent teeth is provided. The dental floss apparatus has a flexible material that extends through the space wherein the flexible material has a first length and a first cross section and further wherein the flexible material has a surface to provide abrasion against the adjacent teeth. Further, the dental floss apparatus has a plurality of projections spaced along the first length of the flexible material wherein each projection has a second cross section and further wherein each projection has a ridge wherein the ridge extends from the projection and is perpendicular to a longitudinal axis of the first length of the flexible material.

In an embodiment, the dental floss apparatus has a first disc, a second disc and a third disc on the first length of flexible material wherein the third disc has a diameter greater than the first disc and the second disc and is positioned between the first disc and the second disc.

In an embodiment, the dental floss apparatus has a first disc, a second disc and a third disc on the first length of flexible material wherein a space is provided between the first disc and the third disc and between the third disc and the second disc wherein the diameter of the third disc is greater than the diameter of the first disc and the second disc.

In an embodiment, the dental floss apparatus has a first disc, a second disc and a third disc on the first length of flexible material wherein the first disc and the second disc have a cross section that is smaller than the third disc.

In an embodiment, the dental floss apparatus has a coating on the surface of the flexible material.

In an embodiment, the dental floss apparatus has bristles extending from the projections.

In another embodiment, a method for providing a dental floss is provided. The method has the step of providing a first length of flexible material wherein the flexible material has a first cross section and a surface. Further, the method has the step of providing a plurality of projections along the first length of flexible material wherein each of the projections has a second length and a second cross section that is greater than the first cross section of the flexible material.

In an embodiment, the method has the step of providing a plurality of bristles on each of the projections wherein the bristles extend radially from the projections and longitudinally along the second lengths of the projections.

In an embodiment, the method has the step of providing ridges in each of the projections.

In an embodiment, the method has the step of coating the surface of the flexible material.

In an embodiment, the method has the step of providing fibers that extend from the projections wherein the fibers are made from plastic.

In an embodiment, the method has the step of providing a first disc and a second disc to the first length of flexible material wherein the first disc and the second disc surround a third disc.

In an embodiment, the method has the step of providing a first disc adjacent to a second disc wherein the first disc has a cross section that is smaller than the cross section of the second disc.

It is, therefore, an advantage of the present invention to provide a dental floss apparatus and a method for cleaning teeth using the dental floss apparatus.

Another advantage of the present invention is to provide a dental floss apparatus and a method for cleaning teeth wherein the dental floss apparatus has elements of different sizes to clean between gaps in the teeth and/or the gums.

Moreover, an advantage of the present invention is to provide a dental floss apparatus and a method for cleaning teeth wherein the dental floss apparatus may contact the teeth and spaces between the teeth.

Another advantage of the present invention is to provide a dental floss apparatus and a method for cleaning teeth using the dental floss apparatus which may reduce an amount of time required for cleaning teeth.

Yet another advantage of the present invention is to provide a dental floss apparatus and a method for cleaning teeth using the dental floss apparatus which may reduce an amount of effort required by the user for cleaning teeth.

Another advantage of the present invention is to provide a dental floss apparatus and a method for cleaning teeth wherein the dental floss apparatus has a retentive ability which may prevent the dental floss apparatus from slipping from the hands of the user.

Yet another advantage of the present invention is to provide a dental floss apparatus and a method for cleaning teeth wherein the dental floss apparatus may be made from a resilient material.

A further advantage of the present invention is to provide a dental floss apparatus and a method for cleaning teeth wherein the dental floss apparatus may clean the gums efficiently.

Also, an advantage of the present invention is to provide a dental floss apparatus and a method for cleaning teeth which may encourage longer flossing times for better cleaning.

An advantage of the present invention is to provide a dental floss apparatus and a method for cleaning teeth which may provide textural elements in various shapes and/or sizes.

Yet another advantage of the present invention is to provide a dental floss apparatus and a method for cleaning teeth which may utilize durable material to avoid tearing and/or breakage of the dental floss apparatus.

Also, an advantage of the present invention is to provide a dental floss apparatus and a method for cleaning teeth wherein the apparatus may be manufactured with various resiliency and/or stiffness to be more comfortable and/or more efficient in cleaning the teeth.

Still another advantage of the present invention is to provide a dental floss apparatus which may prevent an accumulation of plaque on the teeth.

Additional features and advantages of the present invention are described in, and will be apparent from, the detailed description of the presently preferred embodiments and from the drawings.

### BRIEF DESCRIPTION OF THE DRAWINGS

FIG. 1A illustrates a perspective view of a dental floss apparatus having a circular cross section in an embodiment of the present invention.

FIG. 1B illustrates a perspective view of a dental floss apparatus having a rectangular cross section in an embodiment of the present invention.

FIG. 1C illustrates a perspective view of a ribbon dental floss apparatus in an embodiment of the present invention.

FIG. 2 illustrates a side view of a dental floss apparatus and/or system in an embodiment of the present invention.

FIG. 3 illustrates a side view of a dental floss apparatus and/or system in an embodiment of the present invention.

FIG. 4 illustrates a side view of a dental floss apparatus and/or system in an embodiment of the present invention.

FIG. 5 illustrates a side view of a dental floss apparatus and/or system in an embodiment of the present invention.

FIG. 6 illustrates a side view of a dental floss apparatus and/or system in an embodiment of the present invention.

FIG. 7 illustrates a perspective view of a dental floss apparatus and/or system in an embodiment of the present invention.

### DETAILED DESCRIPTION OF THE PRESENTLY PREFERRED EMBODIMENTS

The present invention relates to a dental floss. More specifically, the present invention relates to a dental floss apparatus, a system and a method for cleaning teeth. Further, the present invention relates to a dental floss apparatus having various elements to form a system for cleaning spaces between the teeth and the gums.

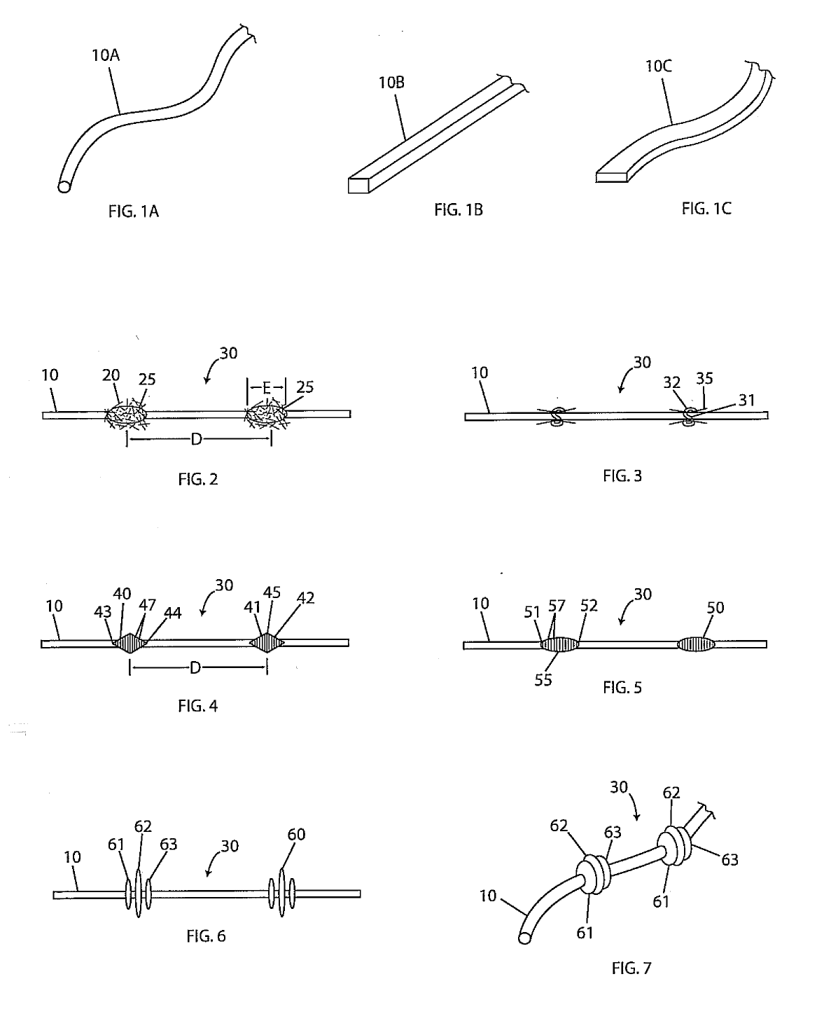

Referring now to the drawings, wherein like numerals refer to like parts, FIGS. 1A-1C illustrate various embodiments of a dental floss apparatus 10 for oral and/or dental hygiene use in a mouth of a user. As shown, the dental floss apparatus 10 may be provided in different shapes and/or with different cross sections. For example, FIG. 1A illustrates an embodiment of a dental floss apparatus 10A having a circular cross section. FIG. 1B illustrates another embodiment of a dental floss apparatus 10B having a rectangular cross section. FIG. 1C illustrates a ribbon dental floss apparatus 10C in yet another embodiment of the present invention. The ribbon dental floss apparatus 10C may also be referred to as dental tape.

Embodiments of the present invention are described, for example, using one of the various shapes of the dental floss apparatus 10 illustrated in FIGS. 1A-1C. Other shapes may also be possible and/or may be used. For example, the circular cross section of the dental floss apparatus 10A shown in FIG. 1A may have a nominal diameter of approximately 1 mm. However, other diameters may be provided. Larger diameters may be more effective in cleaning gaps between the teeth and/or the gums. Smaller diameters may be more effective for cleaning between tight teeth.

Also, embodiments of the dental floss apparatus 10 may be provided having the rectangular cross section dental floss apparatus 10B shown in FIG. 1B. The dental floss apparatus 10B may have a width dimension W and/or a height dimension H of approximately 1 mm. However, other dimensions may be provided as desired and/or as required for certain applications. The rectangular cross section dental floss apparatus 10B may be more effective in cleaning gaps between the teeth and/or the gums than standard floss.

Further, other embodiments of the dental floss apparatus 10 may be provided having the ribbon dental floss apparatus 10C as shown in FIG. 1C. The ribbon dental floss apparatus 10C may have a nominal width of approximately 1 mm. However, other dimensions may be provided as desired and/or as required for certain applications. The ribbon dental floss apparatus 10 may have a surface 11. The surface 11 may be relatively flat. The surface 11 may contact more of the surface area of the teeth during flossing. The greater contact area may remove more plaque and/or debris from the teeth in each pass of the ribbon dental floss apparatus 10C through the teeth.

In an embodiment, the dental floss apparatus 10 may be made using one or more of the following types of materials. For example, the dental floss apparatus 10 may be made from nylon, Polytetrafluoroethylene (PTFE) or Teflon® (a registered trademark of DuPont Corporation), ultra-high molecular weight polyethylene (UHMWPE), polyester and/or the like. The dental floss apparatus 10 may also have a texture to provide more abrasion against the surface of the teeth to remove plaque. The texture may also assist the user in gripping the dental floss apparatus 10.

Certain contact points between teeth may be tight, difficult and/or uncomfortable through which to pass floss. Thus, the dental floss apparatus 10 may be constructed from a material having a coating of silicone and/or like material. The coating on the dental floss apparatus 10 may require less effort from the user when flossing such tight contact points between teeth due to a lesser amount of friction between the dental floss apparatus 10 and the teeth.

The dental floss apparatus 10 may be constructed from a resilient material. The resiliency of the dental floss apparatus 10 may improve the comfort and/or performance of the dental floss apparatus 10 for the user. For example, the dental floss apparatus 10 may be less likely to shred and/or to break during the flossing process. Further, the resiliency of the dental floss apparatus 10 may improve the cleaning performance of the dental floss apparatus 10 between the teeth and/or at the gum line. Moreover, the dental floss apparatus 10 may be a material that may be resistant to kinks, tears and/or the like.

As shown in FIGS. 2-7, a length of the dental floss apparatus 10 may have elements 20 spaced a distance apart from one another. The elements 20 may recur along the length of the dental floss apparatus 10 at regular intervals and/or at varied intervals. The dental floss apparatus 10 and the elements 20 may form a system 30.

In the embodiments shown in FIGS. 2-7, the elements 20 along the length of the dental floss apparatus 10 may be varied in size, shape, thickness, texture, density, hardness, material, resiliency and/or the like. For example, in an embodiment shown in FIG. 2, the elements 20 may be spaced at a consistent distance D from one another. For example, the distance D between successive elements 20 may be approximately five centimeters to approximately fifteen centimeters. The distance D between the elements 20 may also be varied along the length of the dental floss apparatus 10. The user may wrap a portion of the dental floss apparatus 10 between each element 20 around a finger and/or fingers to hold the dental floss apparatus 10 during flossing.

As shown in FIG. 2, an embodiment of the element 20 may have bristles 25. The bristles 25 may extend outwardly from the dental floss apparatus 10. The bristles 25 may extend in a radial direction around the circumference of the dental floss apparatus 10. The bristles 25 may extend approximately two millimeters to approximately five millimeters. The bristles 25 on the element 20 may also extend longitudinally along the length of the dental floss apparatus 10. For example, the bristles 25 may extend a length E as shown in FIG. 2. The length E may be approximately 0.5 centimeters to approximately two centimeters.

While flossing, the bristles 25 may pass through spaces in between the teeth and/or the gums. The bristles 25 may be approximately the same size as the spaces so that the bristles 25 contact the teeth on each side of the spaces to clean the teeth and/or to remove food debris from the spaces. The bristles 25 may act as a scrubbing brush in the spaces. The larger volume and/or the larger cross section of the bristles 25 relative to the dental floss apparatus 10 may remove food and/or other debris from such relatively larger spaces between the teeth. The bristles 25 may range from being relatively rigid to being relatively soft. Rigid bristles 25 may provide more effective cleaning of harder deposits on the teeth, whereas softer bristles 25 may be gentler on the gums and/or in larger spaces between the teeth.

Referring to FIG. 3, the dental floss apparatus 10 may have a knot 31 in each element 20. The knot 31 may be spaced along the length of the dental floss apparatus 10 at a consistent distance D from one another. The knot 31 may provide an anchoring location for other elements 20. For example, a loop 32 may be connected to the knot 31. The loop 32 may extend outwardly from the knot 31. The loops 32 along the length of the dental floss apparatus 10 may be the same size or may be different sizes. For example, the size of the loop 32 may be provided in relative sizes, such as, small, medium or large, for use between teeth and/or for use in spaces of different sizes between the teeth. Multiple sizes of the loops 32 along the length of the dental floss apparatus 10 may provide the user with a selection of loop sizes from which to choose.

Further, more than one loop 32 may be connected to each knot 31. FIG. 3 illustrates two loops 32 located in a position opposite each other or approximately 180 degrees apart. However, the dental floss apparatus 10 may have more than two loops 32 on each knot 31 spaced uniformly around the circumference of the dental floss apparatus 10. Moreover, the loops 32 may be spaced at irregular intervals around the circumference of the dental floss apparatus 10.

Thus, the loops 32 may increase the diameter, the size and/or the volume of the dental floss apparatus 10. The relatively larger size of the dental floss apparatus 10 due to the knot 32 and/or the attached loop 32 may remove food and/or debris between teeth and around the gum line, especially in spaces between the teeth and/or the gums.

Further, the dental floss apparatus 10 may have strings 35 connected to the knot 31 and/or the loop 32. The strings 35 may be provided in some or all of the elements 20 as shown in FIG. 3. The strings 35 may have different attributes. For example, the strings 35 may be smooth, coarse, textured, uniform, irregular, fuzzy, soft, coated and/or the like. The strings 35 may brush against and/or may cause additional friction to the teeth and the gums, especially in the spaces between teeth. The strings 35 may have a brush-like cleaning effect. The strings 35 may move in a different manner and/or a different direction than the loops 32. Thus, the strings 35 and the loop 32 may operate independently from each other to remove food and/or debris from spaces between teeth, from the gum line and/or from between the teeth.

Thus, the strings 35 and/or the loops 32 connected to the knots 31 may increase the diameter, the size and/or the volume of the dental floss apparatus 10. The increased size of the dental floss apparatus 10 due to the knot 32 and/or the attached loop 32 and/or the attached strings 35 may remove food and/or debris between teeth and around the gum line, especially in gaps and/or in spaces between the teeth and/or the gums.

Referring to FIG. 4, the dental floss apparatus 10 may have a conical element 40. The conical element 40 may have a first cone 41 and a second cone 42. The first cone 41 may have a first point 43, and the second cone 42 may have a second point 44. The first cone 41 and the second cone 42 may abut each other as shown in FIG. 4. A high point 45 may be formed in a location at which the first cone 41 and the second cone 42 abut each other. The conical element 40 may have a smooth surface and/or may also have ridges 47 located around the circumference of the conical element 40. The ridges 47 may be located on the first cone 41, the second cone 42 or both.

While flossing, the conical element 40 may pass through spaces in between the teeth and/or the gums. The conical element 40 may be approximately the same size as the space so that the conical element 40 may contact the teeth on each side of the space to clean the teeth and to remove food debris from within the space. The conical element 40 may push debris through the space.

Moreover, the conical element 40 may be suited for cleaning spaces between teeth. For example, during the flossing process, the dental floss apparatus 10 may be pulled in a first direction through the spaces in between the teeth and/or the gums. The first point 43 of the first cone 41 may enter into the space as the dental floss apparatus 10 may be drawn through the space between the teeth. As the user may continue to pass the dental floss apparatus 10 through the space, the high point 45 and the second cone 42 may pass through the space.

In an embodiment, the ridges 47 may rub against the teeth on either side of the space. The ridges 47 may aid in the removal of debris and/or plaque on the teeth. The dental floss apparatus 10 may also be drawn through the space between the teeth in a second direction opposite to the first direction. Thus, the second point 44 of the second cone 42 may enter into the space from the second direction as the dental floss apparatus 10 may be drawn through the space between the teeth.

Further, the relatively larger volume and cross section of the conical element 40 may more effectively remove food and/or other debris from the space between the teeth than typical dental floss. In an embodiment, the conical element 40 may range from being relatively rigid to being relatively soft. A rigid conical element 40 may provide more effective cleaning of harder deposits on the teeth, whereas a softer conical element 40 may be gentler on the gums in larger spaces between the teeth.

Thus, the conical element 40 may increase the diameter, size and/or volume of the dental floss apparatus 10. The increased size of the dental floss apparatus 10 due to the conical element 40 may remove food and/or debris between teeth and around the gum line, especially in spaces between the teeth and/or the gums.

Referring to FIG. 5, the dental floss apparatus 10 may have an elliptical element 50. The elliptical element 50 may have a first end 51 and a second end 52. A relative high point 55 may exist approximately in the center of the elliptical element 50. The elliptical element 50 may have a smooth surface and/or may also have ridges 57 located around the circumference of the elliptical element 50.

While flossing, the elliptical element 50 may pass through spaces in between the teeth and/or the gums. The elliptical element 50 may be approximately the same size as the space so that the elliptical element 50 may contact the teeth on each side of the space to clean the teeth and to remove food debris from within the space. The elliptical element 50 may push debris through the spaces.

Moreover, the elliptical element 50 may be suited for cleaning spaces between teeth. For example, during the flossing process, the dental floss apparatus 10 may be pulled in a first direction through the spaces in between the teeth and/or the gums. The first end 51 of the elliptical element 50 may enter into the space as the dental floss apparatus 10 may be drawn through the space between the teeth. As the dental floss apparatus 10 may continue through the space, the high point 55 may pass through the space.

In an embodiment, the ridges 57 may rub against the teeth on either side of the space. The ridges 57 may aid in the removal of debris and/or plaque on the teeth. The dental floss apparatus 10 may also be drawn through the space between the teeth in a second direction opposite to the first direction. Thus, the second end 52 of the elliptical element 50 may enter into the space from the second direction as the dental floss apparatus 10 may be drawn through the space between the teeth.

Further, the relatively larger volume and cross section of the elliptical element 50 may more effectively remove food and/or other debris from the space between the teeth than typical dental floss. In an embodiment, the elliptical element 50 may range from being relatively rigid to being relatively soft. A rigid elliptical element 50 may provide more effective cleaning of harder deposits on the teeth, whereas a softer elliptical element 50 may be gentler on the gums in larger spaces between the teeth.

Thus, the elliptical element 50 may increase the diameter, size and/or volume of the dental floss apparatus 10. The increased size of the dental floss apparatus 10 due to the elliptical element 50 may remove food and/or debris between teeth and around the gum line, especially in spaces between the teeth and/or the gums.

Referring to FIGS. 6 and 7, the dental floss apparatus 10 may have elements 60 spaced along the length of the dental floss apparatus 10. Each element 60 may have a first disc 61, a second disc 62 and/or a third disc 63. While FIGS. 6 and 7 illustrate three discs in each element 60, other numbers of discs may be provided. The sizes and/or locations of the discs 61, 62, 63 relative to each other may also be varied. The discs 61, 62, 63 may be separated from each other by a space. The space may be uniform or irregular between the discs 61, 62, 63. The discs 61, 62, 63 may be arranged approximately perpendicular to the length of the dental floss apparatus 10.

In an embodiment, the discs 61, 62, 63 may have a circular cross section. However, the discs 61, 62, 63 may have other cross sections and/or shapes. The discs 61, 62, 63 may be flexible and may bend as the dental floss apparatus 10 may be drawn through the spaces between the teeth during a flossing process.

While flossing, the element 60 may pass through spaces in between the teeth and/or the gums. The discs 61, 62, 63 of the element 60 may be approximately the same size as the space so that the discs 61, 62, 63 of the element 60 may contact the teeth on each side of the space to clean the teeth and to remove food debris from within the space. The discs 61, 62, 63 of the element 60 may push debris through the spaces.

Moreover, the discs 61, 62, 63 of the element 60 may be suited for cleaning spaces between teeth. For example, during the flossing process, the dental floss apparatus 10 may be pulled in a first direction through the spaces in between the teeth and/or the gums. The disc 61 of the element 60 may enter into the space as the dental floss apparatus 10 may be drawn through the space between the teeth. As the dental floss apparatus 10 continues through the space, the disc 62 may pass through the space. In an embodiment, the disc 62 may have a larger diameter than the disc 61. Thus, the disc 62 may clean a larger space more effectively that the disc 61. The disc 63 may then pass through the space between the teeth.

The discs 61, 62, 63 of the element 60 may rub against the teeth on either side of the space. The discs 61, 62, 63 of the element 60 may aid in the removal of debris and/or plaque on the teeth. The dental floss apparatus 10 may also be drawn through the space between the teeth in a second direction opposite to the first direction. Thus, the disc 63 of the element 60 may first enter into the space from the second direction as the dental floss apparatus 10 may be drawn through the space between the teeth. The disc 62 and the disc 61 may then follow through the space.

Further, the relatively larger volume and cross section of the discs 61, 62, 63 of the element 60 may more effectively remove food and/or other debris from the space between the teeth than typical dental floss. In an embodiment, the discs 61, 62, 63 of the element 60 may range from being relatively rigid to being relatively soft. A rigid element 60 may provide more effective cleaning of harder deposits on the teeth, whereas a softer element 60 may be gentler on the gums in larger spaces between the teeth.

Thus, the discs 61, 62, 63 of the element 60 may increase the diameter, size and/or volume of the dental floss apparatus 10. The increased size of the dental floss apparatus 10 due to the discs 61, 62, 63 of the element 60 may remove food and/or debris between teeth and around the gum line, especially in spaces between the teeth and/or the gums.

Each embodiment of the dental floss apparatus 10 and/or system 30 may be stored for future use and/or dispensed from a container (not shown). Generally, the container may have the dental floss apparatus 10 and/or system 30 wrapped onto a spool within the container. The dental floss apparatus 10 and/or system 30 may be pulled through an opening in the container and/or cut to a desired length by a cutting edge.

To use the dental floss apparatus 10 and/or system 30 according to the method of the present invention, the user may withdraw a desired length from the container. The user may select the length having a single element 20 and/or multiple elements 20. The user may also determine which type of element may be appropriate for the particular application. For example, larger spaces between the teeth and/or the gums may require a larger and/or firmer element 20. Other smaller spaces, for example, may require a smaller and/or softer element 20.

During the flossing operation, the user may hold onto the dental floss apparatus 10 and/or may hold onto the elements 20. Since some users dislike wrapping floss around their fingers, the system 30 may avoid the discomfort of tightly wound floss on their fingers. The elements 20 may provide the user with a simpler and/or more comfortable manner to maintain control of the dental floss apparatus 10. The user may floss between the teeth with the dental floss apparatus 10 and may utilize the elements 20 for larger spaces between the teeth and the gums. The user may select which size element 20 may best fit the size of the space to be cleaned. If the element 20 may be too large to completely pass through the space, the user may then pull the floss in the opposite direction to remove the element 20 from the space. The user may continue to pull the dental floss apparatus 10 back and forth between the teeth and through the spaces, as needed. Further, the elements 20 may cause the food and/or debris to adhere thereto so that the food and/or debris may be removed from the mouth as the dental floss apparatus 10 may be withdrawn from the mouth. Brushing and/or rinsing may also be used to complete the oral hygiene process.

Moreover, the present invention is not limited to the specific arrangement of the components illustrated in the figures. It should be understood that various changes and modifications to the presently preferred embodiments described herein will be apparent to those having ordinary skill in the art. Such changes and modifications may be made without departing from the spirit and scope of the present invention and without diminishing its attendant advantages. It is, therefore, intended that such changes and modifications be covered by the appended claims.

I claim:

1. A dental floss system for cleaning between adjacent teeth in a mouth of an individual wherein a space is defined between the adjacent teeth, the system comprising:
a flexible material that extends through the space wherein the flexible material has a first length and a first cross section and further wherein the flexible material has a surface to provide abrasion against the adjacent teeth wherein the surface has a first texture; and
a plurality of projections to contact the adjacent teeth wherein the projections are spaced at intervals along the first length of the flexible material wherein each projection has a second length and a second cross section that is greater than the first cross section of the flexible material and further wherein each projection has a second texture that is different than the first texture of the flexible material.

2. The dental floss system of claim 1 further comprising:
a plurality of bristles extending from the projections wherein the bristles extend radially from the projections and longitudinally along the second lengths of the projections.

3. The dental floss system of claim 1 further comprising:
ridges extending from the projections.

4. The dental floss system of claim 1 further comprising:
a coating on the surface of the flexible material.

5. The dental floss system of claim 1 further comprising:
a plurality of fibers extending outwardly from the projections wherein the fibers are made from plastic.

6. The dental floss system of claim 1 further comprising:
a first loop and a second loop extending from the projections.

7. The dental floss system of claim 1 further comprising:
strings extending from the projections wherein the strings and the projections are made from the same material.

8. A dental floss apparatus for cleaning between adjacent teeth in a mouth of an individual wherein a space is defined between the adjacent teeth, the apparatus comprising:
a flexible material that extends through the space wherein the flexible material has a first length and a first cross section and further wherein the flexible material has a surface to provide abrasion against the adjacent teeth; and
a plurality of projections spaced along the first length of the flexible material wherein each projection has a second cross section and further wherein each projection has a ridge wherein the ridge extends from the projection and is perpendicular to a longitudinal axis of the first length of the flexible material.

9. The dental floss apparatus of claim 8 further comprising:
a first disc, a second disc and a third disc on the first length of flexible material wherein the third disc has a diameter greater than the first disc and the second disc and is positioned between the first disc and the second disc.

10. The dental floss apparatus of claim 8 further comprising:
a first disc, a second disc and a third disc on the first length of flexible material wherein a space is provided between the first disc and the third disc and between the third disc and the second disc wherein the diameter of the third disc is greater than the diameter of the first disc and the second disc.

11. The dental floss apparatus of claim 8 further comprising:
a first disc, a second disc and a third disc on the first length of flexible material wherein the first disc and the second disc have a cross section that is smaller than the third disc.

12. The dental floss apparatus of claim 8 further comprising:
a coating on the surface of the flexible material.

13. The dental floss apparatus of claim 8 further comprising:
bristles extending from the projections.

14. A method for providing a dental floss, the method comprising the steps of:
providing a first length of flexible material wherein the flexible material has a first cross section and a surface; and
providing a plurality of projections along the first length of flexible material wherein each of the projections has a second length and a second cross section that is greater than the first cross section of the flexible material.

15. The method of claim 14 further comprising the step of:
providing a plurality of bristles on each of the projections wherein the bristles extend radially from the projections and longitudinally along the second lengths of the projections.

16. The method of claim 14 further comprising the step of:
providing ridges in each of the projections.

17. The method of claim 14 further comprising the step of:
coating the surface of the flexible material.

18. The method of claim 14 further comprising the step of:
providing fibers that extend from the projections wherein the fibers are made from plastic.

19. The method of claim 14 further comprising the step of:
providing a first disc and a second disc to the first length of flexible material wherein the first disc and the second disc surround a third disc.

20. The method of claim 14 further comprising the step of:
providing a first disc adjacent to a second disc wherein the first disc has a cross section that is smaller than the cross section of the second disc.
